(19) United States
(12) Patent Application Publication
(10) Pub. No.: US 2016/0262234 A1
(43) Pub. Date: Sep. 8, 2016

(54) CIRCUIT ASSEMBLY FOR OPERATING AT LEAST A FIRST AND A SECOND CASCADE OF LEDS

(71) Applicant: OSRAM GMBH, München (DE)

(72) Inventor: Andreas SEIDER, Obertaufkirchen (DE)

(21) Appl. No.: 15/033,185

(22) PCT Filed: Sep. 24, 2014
(86) PCT No.: PCT/EP2014/070417

§ 371 Date: Apr. 29, 2016

(30) Foreign Application Priority Data
Oct. 31, 2013 (DE) 10 2013 222 226.2

(51) Int. Cl. H05B 33/08

(52) U.S. Cl. CPC H05B 33/0845; H05B 33/0809; H05B 33/0884

(57) ABSTRACT

A circuit assembly for operating at least a first and a second cascade of LEDs is disclosed. The LED cascades have a different number of LEDs. The LED cascades are operated in alternation by means of a suitable control logic, the operation being adapted to the instantaneous value of the rectified alternating supply voltage. The LED cascades are associated with LED units, wherein each LED unit includes a control device for controlling the particular LED cascade. The LED units are coupled in series between the two input connections, wherein the input connections are formed by the output of a rectifier. A linear controller is provided in series with the LED cascades, which linear controller is controlled via a voltage divider, which is coupled between the two input connections. For adaptation to different alternating supply voltages, a switching device is associated with at least the highest LED cascade.

### RELATED APPLICATIONS

The present application is a national stage entry according to 35 U.S.C. §371 of PCT application No.: PCT/EP2014/070417 filed on Sep. 24, 2014, which claims priority from German application No.: 10 2013 222 226.2 filed on Oct. 31, 2013, and is incorporated herein by reference in its entirety.

### TECHNICAL FIELD

Various embodiments relate to a circuit assembly for operating at least a first and a second cascade of LEDs, including an input with a first and a second input connection for coupling with a rectified alternating supply voltage, a linear controller with an input, and a first, higher LED unit and a second, lower LED unit, wherein the first LED unit includes the first cascade of LEDs and the second LED unit includes the second cascade of LEDs.

### BACKGROUND

A species-related circuit assembly is known from DE 29 25 692 A1. From that document, it is known to supply electrical power to LED cascades, each of which includes a plurality of LEDs, from an alternating voltage network via a rectifier. However, this results in significant light modulation, also referred to as “flickering”, and LED use which is not energy-efficient. For higher performance classes, this approach further leads to problems with normative directives regarding power factor and harmonics.

From DE 20 2013 000 064 U1, successive bridging of the LED cascades based on the voltage of the half-wave is known, wherein a linear controller with sinusoidal current control is connected in series to the LED cascades.

A series connection of multiple LED cascades to a current source, wherein the LEDs within each LED cascade are connected to a switching device in series or in parallel depending on the voltage of the half-wave, is known from EP 2 519 080 A2 (FIG. 4).

A series connection of multiple LED cascades to a current source, wherein the LED cascades are connected to a switching device in series or in parallel and bridged depending on the voltage of the half-wave, is known from DE 10 2012 006 315 A1 (FIG. 4).

Successive bridging of the LEDs according to the voltage of the half-wave, wherein a linear controller with sinusoidal current control is connected in series to the LED cascades, the control input of which controller is coupled to the rectified alternating voltage via a voltage divider, is known from US 2010/0134018 A1 (FIGS. 4-5B).

Successive bridging of the LED cascades according to the voltage of the half-wave, wherein a linear controller is connected in series to the LED cascades, wherein capacitors are connected in parallel to the LEDs, and wherein decoupling diodes are provided in series with the LEDs in such manner that the capacitors are not discharged when the LEDs are bridged, is known from EP 2 645 816 A1 (FIG. 6).

### SUMMARY

Various embodiments provide a species-related circuit assembly for operating at least a first and a second cascade of LEDs so that more efficient operation of the LEDs is possible.

The present disclosure is based on the understanding that the efficiency, and consequently the efficacy, of a species-related circuit assembly can be increased and the regulations regarding the power factor can be satisfied if a voltage divider is provided that is coupled between the first and the second input connections, wherein the pickup of the voltage divider is coupled to the input of a linear controller that is coupled in series to the LED cascades. By this means, a current consumption of the circuit assembly can be rendered dependent on the respective phase position of the rectified alternating supply voltage.

Each LED unit includes a first diode, which is coupled in series to the respective LED cascade, wherein said first diode functions as a blocking diode. The coupling point between the first diode and the respective LED cascade constitutes a first node, wherein the connection of the LED cascade that is not coupled to the first diode constitutes a second node, wherein the connection of the first diode that is not coupled to the LED cascade constitutes a third node. Each LED unit also has the serial connection of a first capacitor and a second diode, which is coupled between the third and the second nodes, wherein the coupling point between the first capacitor and the second diode constitutes a fourth node. Each LED unit also has a first and a second electronic switch, each of which has one control electrode, one reference electrode and one working electrode, wherein the control electrode of the first electronic switch is coupled with a fifth node, wherein the reference electrode of the first electronic switch is coupled with the fourth node, wherein the working electrode of the first electronic switch is coupled with the control electrode of the second electronic switch, wherein the reference electrode of the second electronic switch is coupled with the third node, wherein the working electrode of the second electronic switch is coupled with the second node. As will be explained in greater detail in the following text, in this way it is possible to create the conditions under which the various LED cascades may be switched on or off depending on the current value of the rectified alternating supply voltage. Moreover, it is thus possible for only single LED cascades or also multiple LED cascades to be in operation at the same time. To this end, the third node of the highest LED unit is coupled with the first input connection, wherein the second node of the lowest LED unit is coupled with the linear controller in such manner that the linear controller is coupled serially between the second node of the lowest LED unit and the second input connection. The third node of each LED unit that is not the highest LED unit is coupled with the second node of the next highest LED unit.

Since each first electronic switch is switched by a variation in the potential at the reference electrode, a suitably selected DC voltage must be applied to the control electrode thereof. According to the present disclosure, therefore, the fifth nodes of all LED units are coupled with a DC voltage source.

Moreover, at least the highest LED cascade is assigned a switching device that is designed to switch all LEDs of the LED cascade in series in a first state and to switch a first half of the LEDs in the LED cascade in parallel with a second half of the LEDs in the LED cascade in a second state. This capability addresses the fact that, when a circuit assembly of such type—which is designed for an alternating supply voltage of 200 V for example—is operated on an alternating supply voltage of 100 V, if countermeasures are not taken the luminous flux falls to a very low value. This may happen, for example, if a circuit assembly according to the present disclosure that is designed for the European market is operated with a supply voltage that is usual in Japan, for example. The consequence of this is that some of the LEDs in the various LED cascades no longer light up. This in turn leads to unacceptable variation in luminance.

Conversely, a circuit assembly that is designed to work with the supply from a 100 V network cannot be operated on a 200 V network, because this increases the input power excessively. The luminous efficacy (1 m/W) of the overall system would be very poor. Moreover, there is a risk that the electronic components of the circuit assembly—particularly notably the LEDs in this case—would be destroyed very quickly.

In order to address this problem in the past, species-related circuit assemblies always had to be operated with an external electronic ballast unit with a wide range input. However, not only are such components expensive, they also substantially limit the design of the lights.

With the innovation according to the present disclosure, the voltage that falls as it passes across an LED cascade, the “phase voltage”, can be adjusted to the alternating supply voltage that is actually present. In this way, it is possible to reliably avoid an undesirable inhomogeneity in luminance, a poor level of efficacy and the destruction or premature aging of components of the circuit assembly.

In various embodiments, the lower end of the first half of the LEDs of at least the highest LED cascade serves as a sixth node, and the higher end of the second half of the LEDs of the highest LED cascade serves as a seventh node, wherein the switching device includes a first, a second and a third switch, wherein the first switch is coupled between the sixth and the seventh nodes, wherein the second switch is coupled between the first and the seventh nodes, and wherein the third switch is coupled between the sixth and the second nodes. This is a particularly simple way to enable the phase voltages to be halved correspondingly when the input voltage is halved. The two sublines of the highest LED cascade are switched in series in response to the higher input voltage and in parallel in response to the lower input voltage by means of the switching device.

It may be provided that a switching device is only assigned to the highest LED cascade, but it may equally be provided that a corresponding switching device is assigned to at least one further LED cascade, preferably all further LED cascades.

The voltage divider preferably includes a switch and at least one first and one second Ohmic resistor, wherein the switch is designed and arranged to isolate the second Ohmic resistor from the first Ohmic resistor in a first state and to switch the first and the second Ohmic resistors in parallel in a second state. This switch serves to adjust the current value correspondingly, so that when the alternating supply voltage is halved, twice the current flows through the LED cascade(s), to achieve a constant light output.

In various embodiments, the circuit assembly further includes a control device which is designed and arranged for the purpose of registering the amplitude of the voltage present at the input, wherein the control device is further designed to actuate the at least one switching device and the switch of the voltage divider depending on the registered amplitude of the voltage present at the input. Consequently, the lines and/or the reference current does/do not have to be switched manually. Accordingly, the control device includes an input voltage detection device with a corresponding automatic switching system. This is provided preferably by using a Schmitt trigger and a MOSFET circuit.

In this context, the control device is preferably designed so that in a first state, which correlates to a voltage in a first voltage range at the input, it actuates the at least one switching device in such manner that the corresponding LEDs are switched in series, and actuates the switch of the voltage divider in such manner that the second Ohmic resistor is isolated, and in a second state, which correlates to a voltage in a second voltage range at the input, wherein smaller voltages are associated with the second voltage range than with the first voltage range, it actuates the at least one switching device in such manner that the first half of the LEDs is switched in parallel with the second half, and it actuates the switch of the voltage divider in such manner that the second Ohmic resistor is switched in parallel to the first Ohmic resistor.

In various embodiments, the duty cycles of the respective LED cascades are reduced when the circuit assembly is operated in the second state, in order to provide an overall LED output for the circuit assembly that is substantially equivalent to the output in the first state. This makes it possible to avoid overloading LEDs, as will be explained in still greater detail in the following text.

It has proven advantageous if the LED units each include a different number of LEDs. With this feature, it generally becomes possible to adjust the LED phase voltage to the current value of the rectified alternating supply voltage.

In this context, it may be provided that each higher LED unit includes twice as many LEDs as the LED unit immediately below it. This makes it possible to adjust the phase voltage particularly evenly to the value of the rectified alternating supply voltage.

In particular in a variant in which a switching device is only assigned to the highest LED cascade, it has proven advantageous if the number of LED units does not have a binary structure. In this way, it is still possible to create a reasonable electrical performance characteristic, and at the same time the expenses and costs of assembly for the LED cascades positioned below the highest LED cascade are still reduced due to the savings made on the corresponding switching devices. In an embodiment with three LED units, the first LED unit may include 26 LEDs, for example, the second LED unit may include eight, and the third LED unit four.

In this context, the duty cycles of the LEDs situated below the highest LED cascade are preferably periodically reduced. This makes it possible to reliably avoid overloading these lower LED cascades.

In the LED units in which a switching device is provided, a first capacitor is preferably connected in parallel to the first half of the LEDs, and a second capacitor is connected in parallel to the second half of the LEDs. According to the present disclosure, this then concerns at least the LED unit with the highest LED cascade. In this way, light modulations and flicker phenomena can be reduced in serial operation as well. It is particularly preferable if each further LED unit also includes at least one second capacitor, which is connected in parallel to the respective LED cascade. In this way, the LEDs of the further LED cascades may also be powered from the respective second capacitor in the phases in which the LEDs of the respective cascade are not directly supplied from the rectified alternating supply voltage, either because the rectified alternating supply voltage is smaller than the sum of the forward voltages of the respective LED cascade, or because another LED cascade is active, and the LED cascade in question is currently short-circuited. This results in a further reduction of light modulation, with the consequence that flicker phenomena are then scarcely perceptible by the human eye.

To enable particularly high efficacy of a circuit assembly according to the present disclosure, the DC voltage source is created by using the AC voltage that is present at the second node of the lowest LED unit when the circuit assembly is in operation to generate a DC voltage. Consequently, it is not necessary to provide a separate auxiliary voltage to generate the potential at the fifth node, for example by using a buck converter coupled to the rectifier output; instead, in the present case a particularly cleverly selected AC voltage signal is used within the circuit assembly. As the inventors of the present disclosure recognized, specifically the AC voltage that is present at the second node of the lowest LED unit is particularly suitable, because it is present at the second node practically constantly regardless of the current value of the alternating supply voltage, and is thus permanently available, that is to say also independently of the current value of the alternating supply voltage, to supply the fifth node. The auxiliary voltage generated in the present case has only a small residual ripple, and for this reason very small capacitors can be used compared with other auxiliary voltage supplies. It can be of very simple and compact construction. Furthermore, it is also inexpensive for the same reason. The fact that a current which would otherwise have been converted into dissipation loss in the linear controller is drawn off for the auxiliary voltage supply is particularly advantageous. Consequently, no additional dissipation loss occurs due to the auxiliary voltage supply, which in turn optimizes the efficacy of the circuit assembly. As a result, not only is a circuit assembly according to the present disclosure inexpensive, it is also small.

Each LED unit preferably also includes a third diode, which is coupled between the fifth node and the control electrode of the respective first electronic switch. This third diode serves to protect the control electrode of the respective first electronic switch. If the first electronic switch is designed with appropriate voltage resistance, these third diodes may be omitted.

The DC voltage source particularly preferably includes a charge pump, of which the input is coupled with the second node of the lowest LED unit and the output is coupled with the fifth node of all LED units. When a charge pump is used, it is particularly easy to obtain a DC voltage for supplying the fifth node of all LED units from the AC voltage exiting the second node of the lowest LED unit. The charge pump preferably includes the serial connection of a half-wave rectifier and a voltage limiting device. This makes it possible to provide a voltage supply for the fifth node that remains reliably below a specifiable threshold value. This feature makes it possible to provide an auxiliary voltage with particularly little ripple.

In various embodiments, the DC voltage source includes the serial connection between a resistor and a fourth diode, which is coupled between the second node of the lowest LED unit and the fifth node of all LED units, and the parallel connection of a third capacitor and a zener diode, which is coupled between the fifth node of all LED units and the second input connection.

In this context, the resistor that is connected in series to the fourth diode may have the form of a fixed Ohmic resistor. This is preferable if the circuit assembly does not have to be dimmable. However, if dimming capability is required, the resistor that is connected in series to the fourth diode is provided as a variable resistor in order to create a regulating device for the charge pump. In this case, it is preferable if such a regulating device of the charge pump is designed to regulate the voltage at the fifth node to a specifiable value. This addresses the situation according to which the voltage that drops over the linear regulator, in the present case the voltage at the second node of the lowest LED unit, corresponds to an asymmetrical sawtooth signal with dropouts in the case of leading phase angle or trailing phase angle dimming. The provision of a regulating device in the charge pump ensures that even in this case the third capacitor is supplied with sufficient current to provide a substantially constant, specifiable voltage to the fifth node of all LED units.

The regulating device of the charge pump preferably has the form of an inverting voltage regulator. In this context, the voltage regulator includes a third and a fourth electronic switch, each being equipped with a control electrode, a working electrode and a reference electrode, wherein the control electrode of the third electronic switch is coupled with the anode of the zener diode, its reference electrode is coupled with the second input connection and its working electrode is coupled with the control electrode of the fourth electronic switch, wherein the control electrode of the fourth electronic switch remains coupled to its working electrode via an Ohmic resistor, which working electrode in turn is coupled to the cathode of the fourth diode, wherein the reference electrode of the fourth electronic switch is coupled to the fifth node of all LED units. In this constellation, the third electronic switch measures the current through the zener diode. If a current flow through the zener diode cannot be detected, this means that the voltage at the third capacitor is too low. If a current does not flow through the zener diode, the third electronic switch becomes non-conductive, and conversely, as a result of the function of the Ohmic resistor serving as a pull-up resistor between the working electrode and the control electrode of the fourth electronic switch, this is connected in its conductive state. In this way, a current flow from the second node of the lowest LED unit to the third capacitor and thus to the fifth node of all LED units is enabled.

A capacitor is coupled preferably between the control electrodes of the third and fourth electronic switch on the one hand and the second input connection on the other. This serves to filter out jumps, spikes and the like, and thus renders the assembly less vulnerable to interference.

A regulating device may also be provided to regulate the current through the linear controller, wherein the input of the regulating device is coupled to the fifth node, and the output of the regulating device is coupled to the input of the linear controller. A regulating device of such kind enables regulation of the current through the at least one LED unit depending on the temperature, for example.

Particularly preferably, a regulating device of such kind includes a fifth electronic switch with a control electrode, a reference electrode and a working electrode, and a voltage divider having at least one Ohmic resistor and an NTC resistor, wherein the voltage divider is coupled between the fifth node and the second input connection, wherein the pickup of the voltage divider is coupled to the control electrode of the fifth electronic switch, wherein the reference electrode of the fifth electronic switch is coupled to the second input connection, wherein the working electrode of the fifth electronic switch is coupled to the input of the linear controller. When the circuit assembly is heated up, the voltage at the control electrode of the third electronic switch is thus also increased, with the result that it becomes increasingly conductive. Conversely, this in turn causes the voltage at the input of the linear controller to be correspondingly reduced. In this way, the current through the linear controller is also reduced, and therewith the power that is converted by the LED units. Besides regulating the temperature, this feature also provides a thermal shutoff if a specifiable maximum temperature is exceeded.

Further preferred embodiments are described in the subclaims.

### BRIEF DESCRIPTION OF THE DRAWING(S)

The invention is explained in greater detail below on the basis of an exemplary embodiment, wherein also as before no distinction will be drawn specifically among the claim categories and the features in the context of the independent claims are intended also to be disclosed in other combinations. In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 is a schematic representation of a first embodiment of a circuit assembly according to the present disclosure;

FIG. 2 is a schematic representation of a second embodiment of a circuit assembly according to the present disclosure;

FIG. 3 shows the plot over time of the voltages at different nodes of the circuit assembly of FIG. 2 during operation with a first alternating supply voltage; and

FIG. 4 shows the plot over time of the voltages at different nodes of the circuit assembly of FIG. 2 during operation with a second alternating supply voltage, which is half the magnitude of the alternating supply voltage used in FIG. 3;

FIG. 5 is a schematic representation of an alternative to a subarea of the circuit assembly shown schematically in FIG. 1;

FIG. 6 is a schematic representation of a further alternative to a subarea of the circuit assembly shown schematically in FIG. 1.

### DETAILED DESCRIPTION

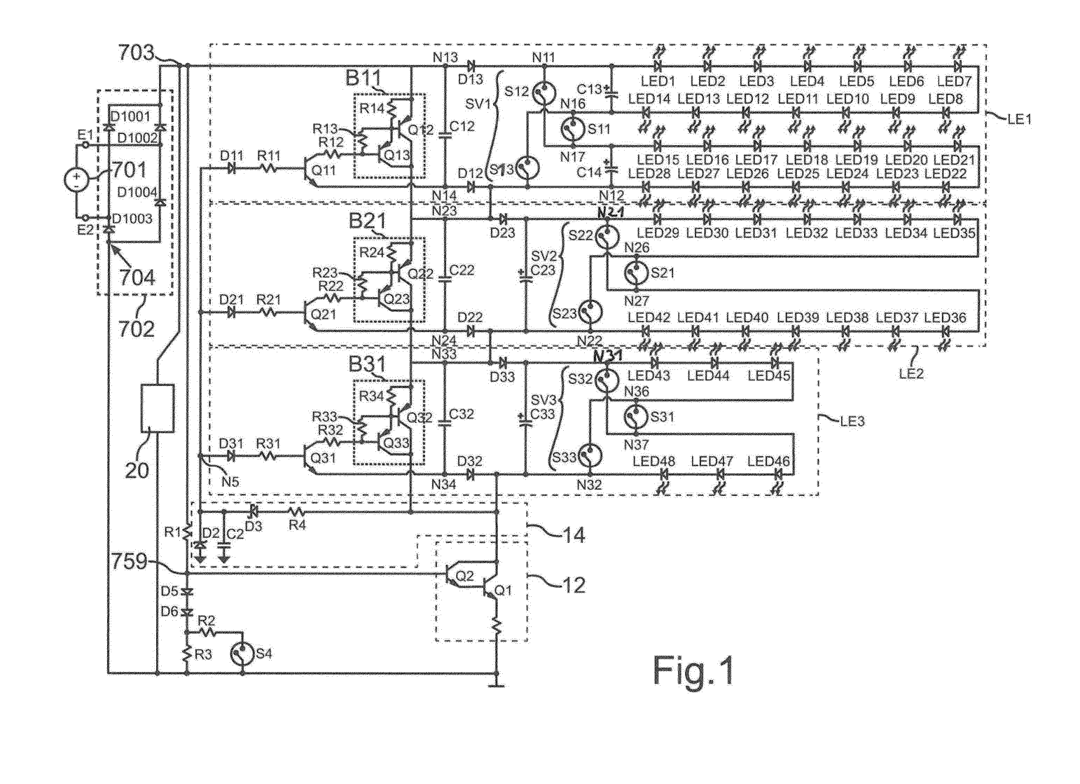

FIG. 1 is a schematic representation of an embodiment of a circuit assembly according to the present disclosure. An AC mains voltage 701 is connected to two nodes 703 and 704 via a rectifier 702. Node 703 is connected to a node 759 via an Ohmic resistor R1. Node 759 is coupled to node 704 via the serial connection of two diodes D5, D6 and an Ohmic resistor R3, wherein the cathode of diodes D5, D6 is directed toward node 704. Ohmic resistors R1, R2, diodes D5, D6 and Ohmic resistor R3 together form a voltage divider, the pickup of which serves as node 759. An Ohmic resistor R2 may be connected in parallel to Ohmic resistor R3 via a switch S4.

The circuit assembly further includes a linear controller 12, which includes two NPN transistors Q1, Q2 in the Darlington configuration and an Ohmic resistor R5 which is coupled in series to said Darlington pair Q1, Q2. The base of transistor Q2 represents the control connection for linear controller 12 and is coupled to node 759.

A serial connection, consisting of three LED units LE1 LE2, LE3 and a linear controller 12 in the present case, is coupled between nodes 703 and 704. In the following text, the structure of an LED unit will be described using the example of LED unit LE3, wherein the structure of LED units LE1 and LE2 is essentially identical, only differing in the numbers of LEDs included in each and the consequent size of the components.

LED unit LE3 includes LEDs LED43 to LED48, that is to say 6 LEDs which are connected to each other in series to form an LED cascade. A diode D33 is serially coupled to the LED cascade, wherein the coupling point between diode D33 and the LED cascade represents a node N31. The connection of the LED cascade that is not coupled to diode D33 represents a node N32. The connection of diode D33 that is not coupled to the LED cascade represents a third node N33. An optional capacitor C33 may be coupled in parallel to the LED cascade. The serial connection between a capacitor C32 and a diode D32 is coupled between node N33 and node N32 wherein the coupling point between capacitor C32 and diode D32 represents a node N34.

LED unit LE3 further includes two electronic switches Q31 and B31, wherein the control electrode of switch Q31 is coupled to a node N5 via the serial connection of a diode D31 and an Ohmic resistor R31. The reference electrode of switch Q31 is coupled to node N34, whereas its working electrode is coupled to the control electrode of switch B31 via an Ohmic resistor R32. The reference electrode of switch B31 is coupled to node N32, whereas its working electrode is coupled to node N33.

In the present embodiment, switch B31 has the form of a Darlington pair and includes transistors Q32, Q33 and Ohmic resistors R33 and R34. However, a single transistor might also be provided instead of the Darlington pair.

LED units LE2, LE1 are similarly constructed, but they each include different numbers of LEDs. For example, LED unit LE2 includes LEDs LED29 to LED42, that is to say 14 LEDs. LED unit LE1 includes LEDs LED1 to LED28, that is to say 28 LEDs. The LEDs are preferably designed as dual core LEDs, each with two PN junctions.

The second node of the lowest LED unit, in the present example node N32, is coupled to the working electrode of linear controller 12, while the third node N13 of the highest LED unit LE1 is coupled to node 703. An auxiliary voltage source 14, which will be discussed in greater detail later in this document, is coupled between node N5 and linear controller 12.

For exemplary purposes, the circuit assembly represented in FIG. 1 has the following components and dimensions: R1 200 kΩ, R2 1.5 kΩ, R3 1.5 kΩ, R5 10Ω, R11 100 kΩ, R21 500 kΩ, R31 10 kΩ, R12 500 kΩ, R22 20 kΩ, R32 10 kΩ. R13=R23=R33=R43 10 kΩ, R14=R24=R34=R44 1 kΩ, C12=470 nf, C13=C14=47 nf, C22=2 μf, C32=4 μf, C23=100 μf, C33=220 μf, R4=3 kΩ, C2=10 μf.

Capacitors C13, C14, C23 and C33 are of relatively large dimensions and function as buffer capacitors for the LEDs of the respective LED cascade. In this context, it is advantageous that these capacitors only have to be designed for the falling voltage at the corresponding LED cascade, and therefore do not have to be able to handle the full magnitude of mains AC voltage V1. Accordingly, these capacitors may be of smaller size, and thus take up less room.

Diodes D11, D21, D32, are optional and may be omitted if transistors Q11, Q21 and Q31 are designed with appropriate voltage resistance.

Within the voltage divider, diodes D5 and D6 serve to compensate for the base-emitter voltage of transistors Q1 and Q2. The falling voltage at Ohmic resistor R3 is therefore substantially equivalent to the falling voltage across Ohmic resistor R5. Thus, the current through resistor R5 is semi-sinusoidal. Accordingly, the current through the circuit assembly follows the input voltage, resulting in a good power factor and low EMC interference.

With the dimensioning of the circuit assembly shown in FIG. 1, it is possible for transistor B11 to be operated with a switching frequency of about 100 Hz. Any flickering that might possibly be perceptible at this switching frequency is prevented by the assigned buffer capacitors C13 and C14. Transistor B21 functions with a switching frequency of about 200 Hz and switch B31 with a switching frequency of about 400 Hz.

The combination of capacitor C12 and diode D12 functions as a peak detector for LED unit LE1. Similarly, capacitor C22 and diode D22 function as a peak detector for LED unit LE2, and capacitor C32 and diode D32 function as a peak detector for LED unit LE3.

Transistors Q11, Q21 and Q31 serve as comparators. Their mode of operation will be described in the following text using the lowest LED unit LE3 for exemplary purposes.

Resistor R32 in combination with capacitor C32 is designed such that capacitor C32 is only slightly discharged even during the longest expected switch-on phase of switch B31. Voltage source 14 sets a voltage offset, in the order of 6 V, for example, as the minimum voltage below which the voltage at switch Q1, Q2 of linear controller 12 must not fall. Transistor Q31 compares the voltage of 6 V with the voltage at node N34. If switch B31 allows the through-connection, LEDs LED43 to LED48 are bridged, that is to say short-circuited. This also offsets the working points of the remaining actuating units for the LEDs of LED units LE2 and LE1.

Regarding the mode of operation, the circuit assembly represented in FIG. 1 will first be considered in a state in which switches S12, S13, S22, S23, S32, S33 are non-conducting, while switches S11, S21 and S31 are conducting. Switches S11, S12 and S13 form a switching device SV1, switches S21, S22 and S23 form a switching device SV2, and switches S31, S32 and S33 form a switching device SV3. A control device 20 will not be discussed here.

In the following explanation, the start of a half-wave of AC voltage source 701 is assumed as the switch-on time. It is further assumed that all switches of the LED units, that is switches Q11, B11, Q21, B21, Q31, B31, are conducting and all capacitors are charged (steady state). The forward voltage of an LED is assumed to be 3 V, that of a diode is assumed to be 0.7 V.

As a consequence of the switches in the conducting state, the current output voltage of rectifier 702 at node 703 is also present at point N32. Nodes N32 and N33 lie on the same potential because switches Q32 and B31 have been assumed to be conducting. The voltage supplied by auxiliary voltage source 14 at node N5 is assumed to be 6 V in the embodiment.

Let capacitor C32 be charged to +18 V from the previous cycle at the start of the half-wave. These 21 V are obtained from 6 times the forward voltages from diodes LED43 to LED48, wherein each forward voltage, as explained previously, is assumed to be 3 V. This results in a potential of −18 V at node N34.

Node N5 is charged to 6 V by auxiliary voltage source 14. This allows current to flow through diode D31, resistor R31 and transistor Q31. Transistor Q31 is conducting, since a potential of about 6 V is present at its base and a potential of about minus 18 V is present at its emitter. Since transistor Q31 is conducting, switch B31 is also conducting. Accordingly, the current flows past the LED cascade of LED unit LE3, which means that the LED cascade is short-circuited and not energized. According to convention, switches B21 and B11 are also conducting, so that the LED cascades of LED units LE1 and LE2 are also not energized. This situation represents the starting point of a half-wave of rectified AC mains voltage V1.

As the half-wave develops, the potential of the half-wave rises. Because of the increasing potential created thereby at node 759, linear controller 12 gradually starts to become conducting.

As long as switches Q31 and B31 are conducting, the potential at node N33 is equal to the potential at node N32. As the half-wave develops, the potential at node N33 continues to rise until the potential at node N34 is about 5.3 V (potential at node N5 minus the forward voltage of diode D31). At this point in time, the base-emitter voltage of transistor Q31 becomes 0 V. Since the voltage drop over capacitor C32 is 18 V, this is accordingly the case when the potential at node N32 is 26.3 V. At this point in time, switches Q31 and B31 go into the blocking state, which means that the potentials at nodes N33 and N32 are decoupled. The potential at node N33 remains at 26.3 V.

Since linear controller 12 is designed to maintain the current flow through Ohmic resistor R5 matching the requirement of the voltage divider in response to a corresponding actuation by the voltage divider, linear controller 12 becomes progressively conducting, which in turn causes the potential at node N32 to fall until the set current is established. This is the case when the voltage at node N32 has fallen to 4.6 V. This value is obtained from the potential at node N33 which, as explained above, has a value of 26.3 V minus 7 times the diode forward voltage of 3 V, minus 0.7 V for the forward voltage of diode D33 after switches Q31 and B31 are switched to “non-conducting mode”. In this way, the conditions are created that enable the current to flow through the LED cascade of LED unit LE3, which is why this cascade is lit after this point in time (if optional capacitor C33 is absent; if it is present, the charging thereof must be taken into account).

Subsequently, the half-wave continues to rise, causing the potential at node N33 to increase further. Consequently, the potential at node N32 also increases across conducting LEDs LED43 to LED48. The voltage difference between the potential at node N33 and at node N32 has a value of 26.3 V−4.6 V=21.7 V. Capacitor C22 is charged to 14×3 V=42 V (14 times the forward voltage of diodes LED29 to LED42).

When the half-wave rises to 26.7 V, these 26.7 V are present at node N23, since all of the switches Q11 and B11 above this are conducting. Therefore, the voltage at node N24 is 26.7 V−42 V=−15.3 V. Since the voltage at node N5 is still 6 V, switches Q21 and B21 are conducting. As the half-wave continues to rise, the potential at node N23 increases, and with it the potential at node N24. When the potential at node N24 has reached 5.3 V (potential at node N5 of 6 V minus base-emitter voltage of switch Q21) switch Q21 and therewith switch B21 change to the non-conducting state. As the input voltage continues to rise, the potential at node N23 continues increasing until 47.3 V are reached (5.3 V at node N24 plus 14 times 3 V). This is the point in time from which the current begins to flow through the LED cascade LED29 to LED42 of LED unit LE2. Thus, for an input voltage of 47.3 V, the drop is 14 times 3 V plus 0.7 V (14 times the forward voltage of LEDs LED29 to LED42 plus the forward voltage of diode D23), with the result that the potential at node N22 is now only 4.6 V. Since node N22 corresponds to node N23, the potential at node N23 is thus also only 4.6 V. Therefore, the potential at node N24 is 4.6 V minus 21.0 V (corresponding to the potential at node N23 less the voltage falling across capacitor C22), equaling minus 16.4 V. Thus, the voltage difference between node N5 and node N24 is −22.4 V, as a result of which transistor Q21 and therewith switch B21 become conducting again. This causes LED cascade LED43 to LED48 of LED unit LE3 to be short-circuited again, in other words, it is no longer energized.

The LED cascades of LED unit LE1 are energized in a corresponding manner.

| Switching | | | |
|---|---|---|---|
| operation | Cascade 1 | Cascade 2 | Cascade 3 |
| 1 | 0 | 0 | 0 |
| 2 | 0 | 0 | 1 |
| 3 | 0 | 1 | 0 |
| 4 | 0 | 1 | 1 |
| 5 | 1 | 0 | 0 |
| 6 | 1 | 0 | 1 |
| 7 | 1 | 1 | 0 |
| 8 | 1 | 1 | 1 |
| 9 | 1 | 1 | 1 |
| 10 | 1 | 1 | 0 |
| 11 | 1 | 0 | 1 |
| 12 | 1 | 0 | 0 |
| 13 | 0 | 1 | 1 |
| 14 | 0 | 1 | 0 |
| 15 | 0 | 0 | 1 |
| 16 | 0 | 0 | 0 |

When the half-wave has exceeded its maximum, the reverse effect begins, which means that the LED cascades of LED units LE1, LE2 and LE3 are switched one after the other according to the order described previously, until a phase angle of 180° is reached and all LED cascades are bridged again (B11 to B31 conducting) and a new half-wave begins.

The following notes relate to a particularly advantageous variation for providing the potential at node N5.

Typically, a buck converter coupled to the output of the rectifier is used to supply an auxiliary voltage. According to the present disclosure, however, the voltage drop at linear controller 12, that is to say the voltage at node N32, is used to generate an auxiliary voltage for node N5. By virtue of the binary arrangement of the LED cascades, a sawtooth-like voltage becomes available at linear controller 12, and alternates between 0 and 26.7 V until all of the LED cascades are switched in. Once all LED cascades have been activated, a voltage at the linear controller derived from the difference between the input voltage and the sum of the voltages falling across the LED cascades drops off. Since the voltage peaks of this sawtooth-like voltage are temporally well distributed within a half-wave, this sawtooth-like voltage may be used to generate an auxiliary voltage with the aid of an RC circuit R4, C2 together with rectifier and zener diode D3, D2. This auxiliary voltage has only a small residual ripple, and for this reason it is possible to use capacitances that are much smaller than other auxiliary voltage supplies. It is constructed very simply, and can be extremely compact. Moreover, for the same reason it is also inexpensive. The fact that a current which would otherwise have been converted into dissipation loss in linear controller 12 is drawn off for the auxiliary voltage supply is particularly advantageous. Thus, according to the present disclosure a parasite power is used to generate the auxiliary voltage at node N5. Consequently, no additional dissipation loss occurs due to the auxiliary voltage supply, and the efficacy of the circuit assembly is optimized.

Regarding the further mode of operation of the circuit assembly taking into account the switching devices SV1, SV2 and SV3 and control device 20:

Control device 20 is coupled between connections 703 and 704 and is designed to detect the amplitude of the rectified alternating supply voltage.

Control device 20 controls switches S11, S12, S13, S21, S22, S23, S31, S32 and S33 depending on the voltage detected. For example, if the control device detects a voltage of 200 V at the input, it actuates the switches as follows: S12, S13, S22, S23, S32, S33 non-conducting and S11, S21, S31 conducting. Control device 20 further actuates switch S4, in such manner that it is non-conducting in the specified voltage range. By the circuit arrangement described, all LEDs of LED unit LE1 are connected in series. The same applies for the LEDs of LED unit LE2 and LED unit LE3.

If control device 20 determines that the voltage at the rectifier output lies in a second voltage range, which is lower than the first voltage range, that is to say the voltage has a value of 100 V for example, it actuates the switches as follows: S12, S13, S22, S23, S32, S33 conducting, and S11, S21 and S31 non-conducting. Switch S4 is also connected in conducting mode.

With this feature, a first half of LED unit LE1, including LEDs LED1 to LED14, is now connected in parallel to a second half of the LED unit, including LEDs LED15 to LED28. The same applies for LED unit LE2: In this case, the switch setting described connects LEDs LED28 to LED35 in parallel with LEDs LED36 to LED42. In the case of LED unit LE3, the serial connection of LEDs LED43 to LED 45 is connected in parallel to the serial connection of LEDs LED46 to LED 48.

Since switch S4 is in conducting mode, it is now possible for twice the current to flow through the respectively active LED units LE1, LE2 and/or LE3 (compared with the state in which switch S4 is in non-conducting mode).

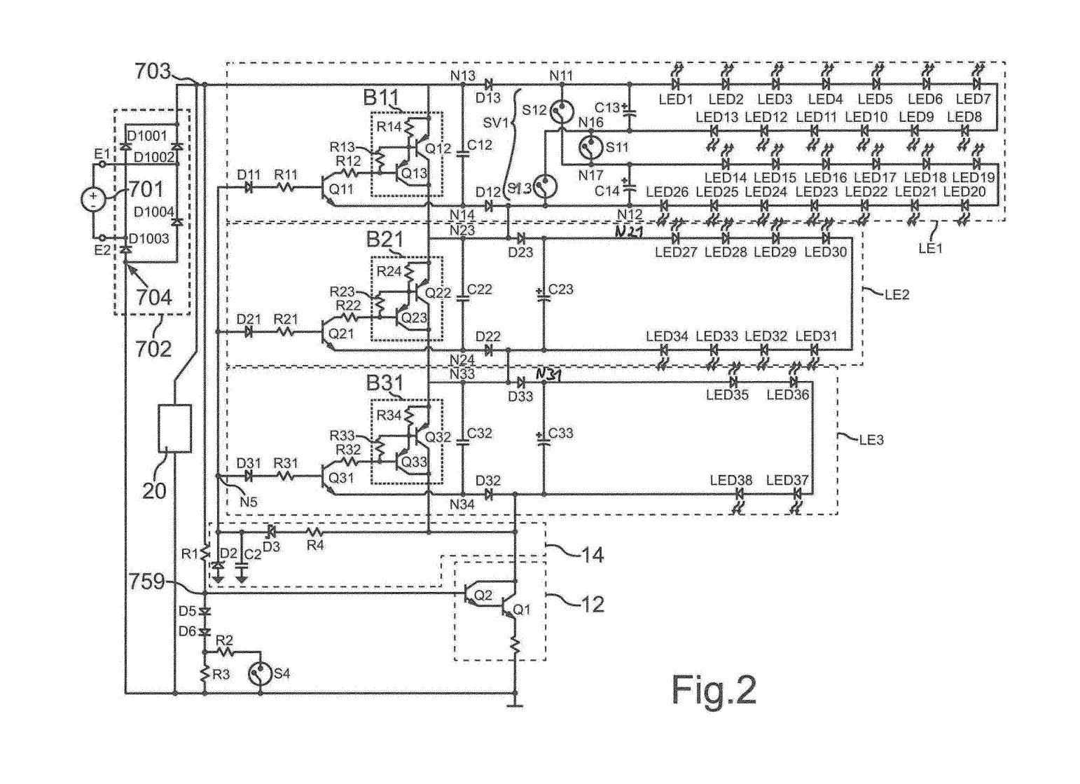

In the embodiment of a circuit assembly according to the present disclosure represented in FIG. 2, only LED unit LE1 has a switching device SV1. The numbers of LEDs in the respective LED units are also different from those shown in FIG. 1. Thus for example, LED unit LE1 includes LEDs LED1 to LED26, that is to say 26 LEDs, LED unit LE2 includes LEDs LED27 to LED34, that is to say eight LEDs, and LED unit LE3 includes LEDs LED35 to LED38, that is to say four LEDs. The illustrated non-binary composition of LED units LE1, LE2 and LE3 with LEDs enables the realization of a fitting electrical performance characteristic even when, as shown, only LED unit LE1 includes a switching device SV1.

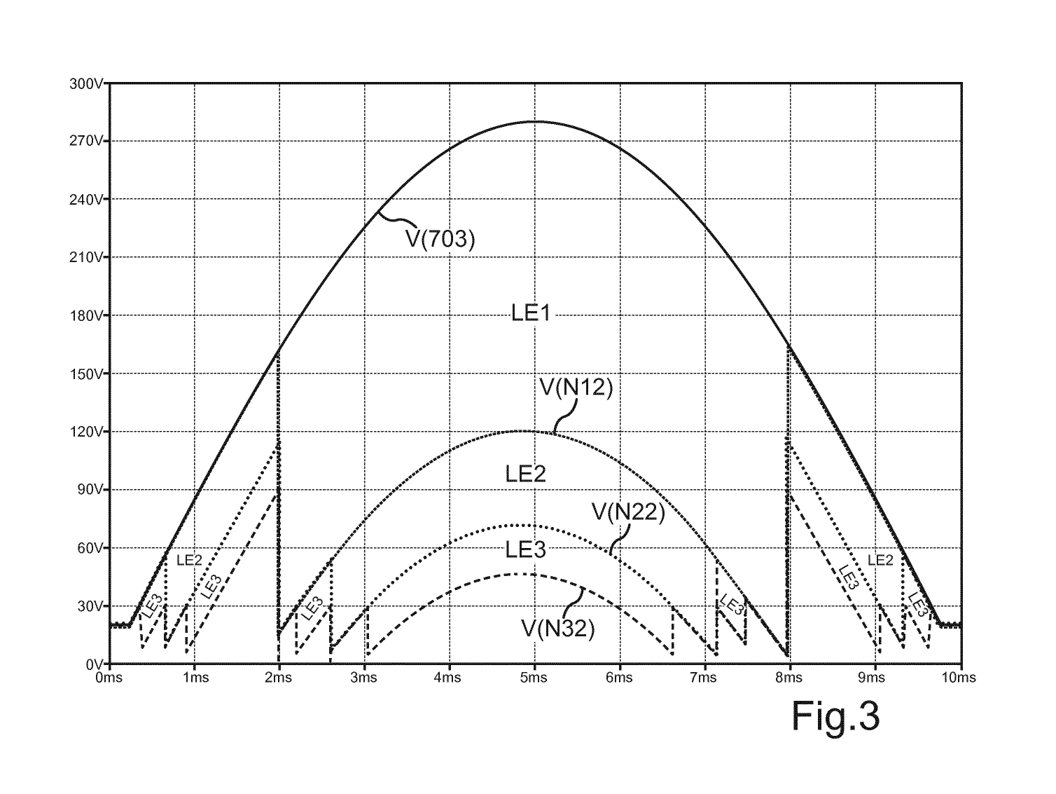

In this context, FIG. 3 shows the plot over time of the voltages at nodes 703, N12, N22 and N32 during operation with an input alternating supply voltage of 200 V. As was mentioned previously, in this case the LEDs of LED unit LE1 are connected in series by corresponding actuation of switching device SV1. In FIG. 3, captions in the respective enclosed areas indicate which LED unit is responsible for the associated voltage drop, in other words, which LED unit is switched on.

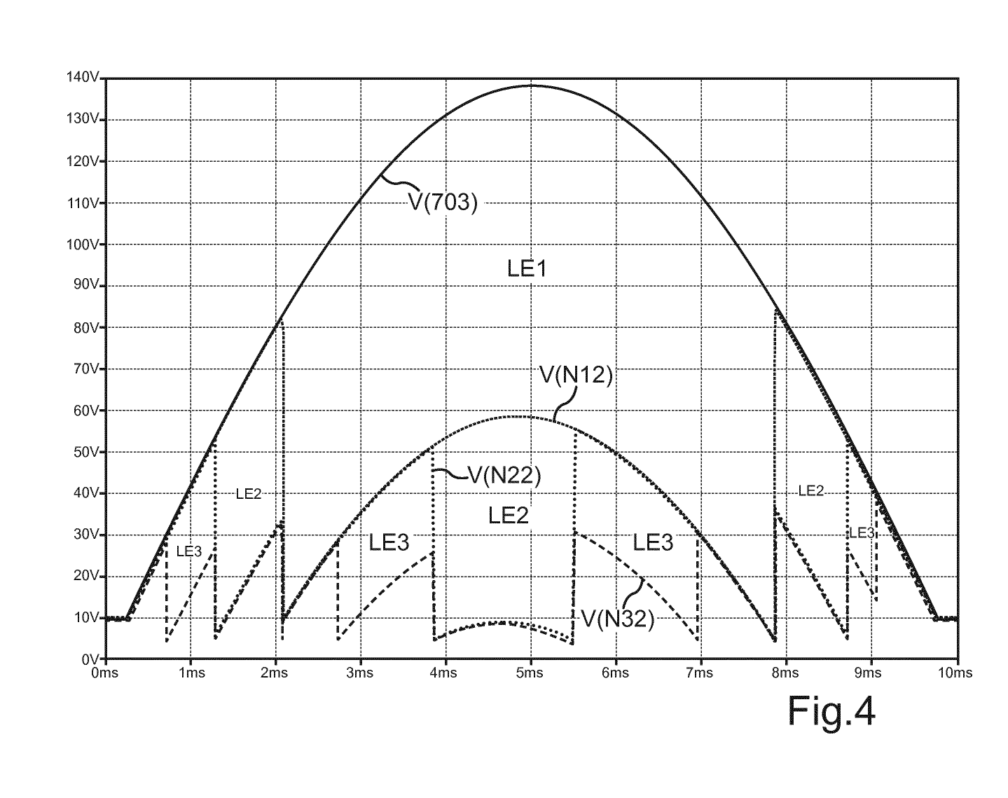

FIG. 4 shows the plot over time of the corresponding magnitudes, but with the circuit assembly of FIG. 2 operated with an alternating supply voltage of 100 V.

When the LEDs consist of dual core LEDs, this then leads to the following situation for the embodiment represented in FIG. 2:

LED unit LE1 has 52 serially connected PN junctions when operated at 200 V and two strings connected in parallel, each of 26 serial PN junctions, when operated at 100 V; string 2 has serially connected PN junctions; and string 3 has eight serially connected PN junctions.

In 100 V mode, a corresponding setting of switch S4 of linear controller 12 switches to double current, such that the appropriate nominal current for the double parallel connection of 26 LEDs each is set in string 1. However, this might cause strings 2 and 3 to be overloaded. It may therefore be provided to correspondingly reduce the periodically repeating duty cycles thereof.

In this way, measured in 200 V mode, the total LED output remains constant in 100 V mode as well.

The forward voltages of strings 1 and 2 are deliberately selected through the appropriate number of LEDs, so that the 3rd string is no longer activated in the supply voltage maximum) (90°. States 8 and 9 listed in the table shown previously are not reached. This prevents the LEDs in the 3rd string from being overloaded.

The duty cycle of string 2 may be shortened if string 1 is released earlier and remains active for longer in the 100 V mode than in the 200 V mode, and if the switch-on phase of string 2 is selected to be considerably shorter around the supply voltage maximum than in the 200 V mode. Both are achieved when the resulting forward voltage of string 1 is selected to be less than twice the forward voltage of string 2 by equipping accordingly with LEDs.

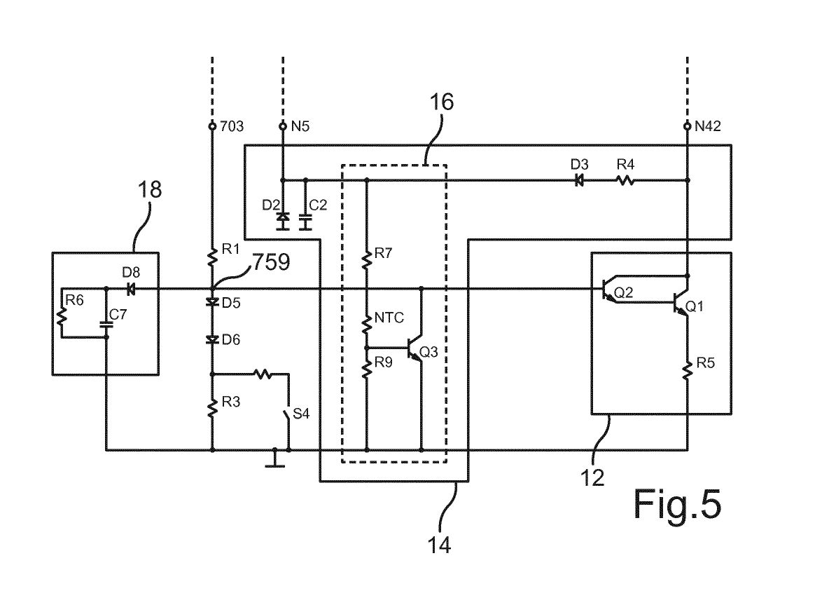

FIG. 5 shows an alternative embodiment of auxiliary voltage supply 14. This further includes a regulating device 16 for regulating the current through linear controller 12. The input of regulating device 16 is coupled to node N5, the output thereof is coupled to the control electrode of switch Q2. Regulating device 16 includes a transistor Q3 and a voltage divider which includes Ohmic resistors R7 and R9 and an NTC resistor. The pickup of the voltage divider is coupled to the control electrode of transistor Q3. The collector of transistor Q3 is coupled to the control electrode of switch Q2.

As soon as the temperature of the circuit assembly rises, transistor Q3 becomes increasingly conducting, which causes switch Q1 to change over increasingly to the blocking state. This in turn reduces the current through resistor R5, thus lowering the power that is utilized in the LEDs. When the temperature becomes so high that switch Q3 is fully conducting, a thermal shutoff of the circuit assembly is carried out. Regulating device 16 is operated by means of the auxiliary voltage at node N5.

FIG. 5 also shows an inrush current delay arrangement, including diode D8 and the parallel connection of capacitor C7 with Ohmic resistor R6. This enables the voltage at the base of transistor Q2 to be increased slowly at first, until capacitor C7 is charged to its peak value. The advantage of this is that unacceptably high dissipation loss does not occur in transistor Q1 at the time of activation. It also enables multiple modules to be operated on a house fuse without causing the fuse to trip during switch-on.

In a preferred embodiment, R9 has a value of 500Ω, the NTC resistor 47 kΩ, R7 500Ω, R4 10 kΩ, C2 10 μf, C7 10 μf and R6 200 kΩ.

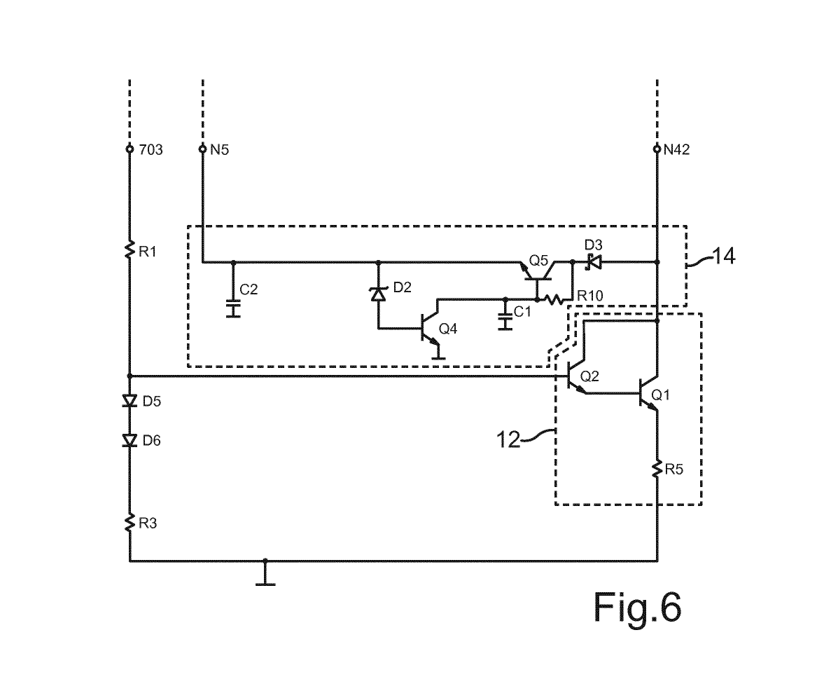

FIG. 6 is a schematic representation of a further alternative to a subarea of the circuit assembly according to the present disclosure shown in FIG. 1. In this embodiment, Ohmic resistor R4, see FIG. 1, is in the form of a variable resistor, thus assuring regulation of the voltage at node N5. This renders the circuit assembly usable for dimming operation. In leading phase angle and trailing phase angle dimmers, the voltage available at linear controller 12 in particular is sometimes no longer sufficient to maintain the auxiliary voltage at node N5. To reliably prevent this, the dimensions of Ohmic resistor R4 for the auxiliary voltage supply would have to be relatively small. This would have negative effects on switching efficiency and EMC performance.

For this reason, in the embodiment represented in FIG. 6 an inverting voltage regulator is provided in charge pump 14, providing increased efficiency of the circuit assembly as well as dimming capability. The voltage regulator includes two electronic switches Q4, Q5, each of which has a control electrode, a working electrode and a reference electrode. The control electrode of switch Q4 is coupled to the anode of zener diode D2, its reference electrode is coupled to the reference potential, in the present case second input connection 704, and its working electrode is coupled to the control electrode of switch Q5. The control electrode of switch Q5 is coupled to its working electrode via a pull-up resistor R10, which is itself coupled to the cathode of diode D3. Its reference electrode is coupled to node N5. In order to improve the resistance to interference of the circuit assembly, a capacitor C1 is provided which is coupled between the control electrodes of switches Q4 and Q5 and the reference potential.

Regarding the mode of operation: switch Q4 measures the current that flows through zener diode D2, and whenever zener diode D2 is non-conducting, the voltage at capacitor C2 is too low. When no current flows through zener diode D2, switch Q4 becomes non-conducting. A connection is made through Q5 whenever the voltage at its collector is greater than at the emitter due to pull-up resistor R4, thereby supplying capacitor C2 with charge carriers. Accordingly, switch Q5 is activated when the voltage at linear regulator 12 is greater than the sum of the forward voltage of diode D3, the base-emitter voltage of switch Q5 and the voltage at capacitor C2.

If the voltage at capacitor C2 is large enough, Q4 becomes conducting, and so draws charge carriers away from the base of switch Q5.

In this way, constant voltage is supplied to node N5 even when an asymmetrical, sawtooth voltage is present at linear regulator 12 as is the case with leading phase angle and trailing phase angle dimming.

In a preferred embodiment, R10 has a value of 1 kΩ and C1 200 nF.

As is evident to a person skilled in the art, the present disclosure may also be designed with a different number of LED units, with different numbers of LEDs or for other alternating supply voltages.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A circuit assembly for operating at least a first and a second cascade of LEDs, comprising:
an input with a first and a second input connection for coupling with a rectified alternating supply voltage;
a linear controller with an input;
at least a first, higher LED unit and a second, lower LED unit, wherein the first LED unit comprises the first cascade of LEDs and the second LED unit comprises the second cascade of LEDs; and
a voltage divider that is coupled between the first and the second input connection, wherein the pickup of the voltage divider is coupled to the input of the linear controller;
wherein each LED unit further comprises:
a first diode, which is coupled in series to the respective LED cascade, wherein the coupling point between the first diode and the respective LED cascade constitutes a first node, wherein the connection of the LED cascade that is not coupled to the first diode constitutes a second node, wherein the connection of the first diode that is not coupled to the LED cascade constitutes a third node;
the serial connection of a first capacitor and a second diode, which is coupled between the third and the second nodes, wherein the coupling point between the first capacitor and the second diode constitutes a fourth node; and
a first and a second electronic switch, each of which has one control electrode, one reference electrode and one working electrode, wherein the control electrode of the first electronic switch is coupled with a fifth node, wherein the reference electrode of the first electronic switch is coupled with the fourth node, wherein the working electrode of the first electronic switch is coupled with the control electrode of the second electronic switch, wherein the reference electrode of the second electronic switch is coupled with the third node, wherein the working electrode of the second electronic switch is coupled with the second node;
wherein the third node of the highest LED unit is coupled with the first input connection, wherein the second node of the lowest LED unit is coupled with the linear controller in such manner that the linear controller is coupled serially between the second node of the lowest LED unit and the second input connection;
wherein the third node of each LED unit that is not the highest LED unit is coupled with the second node of the next highest LED unit;
wherein the fifth nodes of all LED units are coupled with a DC voltage source;
wherein at least the highest LED cascade is assigned a switching device that is designed to switch all LEDs of the LED cascade in series in a first state and to switch a first half of the LEDs in the LED cascade in parallel with a second half of the LEDs in the LED cascade in a second state.

2. The circuit assembly as claimed in claim 1,
wherein
the lower end of the first half of the LEDs of at least the highest LED cascade serves as a sixth node, and the higher end of the second half of the LEDs of the highest LED cascade serves as a seventh node,
wherein the switching device comprises a first, a second and a third switch,
wherein the first switch is coupled between the sixth and the seventh nodes, wherein the second switch is coupled between the first and the seventh nodes, and wherein the third switch is coupled between the sixth and the second nodes.

3. The circuit assembly as claimed in claim 1, wherein
a corresponding switching device is assigned to at least one further LED cascade, preferably all further LED cascades.

4. The circuit assembly as claimed in claim 1,
wherein
the voltage divider comprises a switch and at least one first and one second Ohmic resistor, wherein the switch is designed and arranged to isolate the second Ohmic resistor from the first Ohmic resistor in a first state and to switch the first and the second Ohmic resistors in parallel in a second state.

5. The circuit assembly as claimed in claim 1,
further comprising a control device which is designed and arranged for the purpose of registering the amplitude of the voltage present at the input, wherein the control device is further designed to actuate the at least one switching device and the switch of the voltage divider depending on the registered amplitude of the voltage present at the input.

6. The circuit assembly as claimed in claim 5,
wherein
the control device is designed so that,
in a first state, which correlates to a voltage in a first voltage range at the input, it actuates the at least one switching device in such manner that the corresponding LEDs are switched in series, and actuates the switch of the voltage divider in such manner that the second Ohmic resistor is isolated,
and in a second state, which correlates to a voltage in a second voltage range at the input, wherein smaller voltages are associated with the second voltage range than with the first voltage range, it actuates the at least one switching device in such manner that the first half of the LEDs is switched in parallel with the second half, and it actuates the switch of the voltage divider in such manner that the second Ohmic resistor is switched in parallel to the first Ohmic resistor.

7. The circuit assembly as claimed in claim 6,
wherein
the duty cycles of the respective LED cascades are reduced when the circuit assembly is operated in the second state, in order to provide an overall LED output for the circuit assembly that is substantially equivalent to the output in the first state.

8. The circuit assembly as claimed in claim 1,
wherein
the LED units each comprise a different number of LEDs.

9. The circuit assembly as claimed in claim 8,
wherein
each higher LED unit comprises twice as many LEDs as the LED unit immediately below it.

10. The circuit assembly as claimed in claim 8,
wherein
a switching device is only assigned to the highest LED cascade, wherein the number of LEDs of the LED units does not have a binary structure.

11. The circuit assembly as claimed in claim 1,
wherein
the DC voltage source is created by using the AC voltage that is present at the second node of the lowest LED unit when the circuit assembly is in operation to generate a DC voltage.

12. The circuit assembly as claimed in claim 1,
wherein
a first capacitor is connected in parallel to the first half of the LEDs of at least the highest LED cascade, and a second capacitor is connected in parallel to the second half of the LEDs of at least the highest LED cascade.

13. The circuit assembly as claimed in claim 1,
wherein
each LED unit also comprises a third diode, which is coupled between the fifth node and the control electrode of the respective first electronic switch.

14. The circuit assembly as claimed in claim 1,
wherein
the DC voltage source comprises a charge pump, of which the input is coupled with the second node of the lowest LED unit and the output is coupled with the fifth node of all LED units.

15. The circuit assembly as claimed in claim 14,
wherein
the charge pump comprises the serial connection of a half-wave rectifier and a voltage limiting device.

16. The circuit assembly as claimed in claim 1,
wherein
the DC voltage source comprises the serial connection between an Ohmic resistor and a fourth diode, which is coupled between the second node of the lowest LED unit and the fifth node of all LED units, and the parallel connection of a third capacitor and a zener diode, which is coupled between the fifth node of all LED units and the second input connection.

17. The circuit assembly as claimed in claim 16,
wherein
the resistor that is connected in series to the fourth diode has the form of a fixed Ohmic resistor.

18. The circuit assembly as claimed in claim 16,
wherein
the resistor that is connected in series to the fourth diode is provided a variable resistor in order to create a regulating device for the charge pump.

19. The circuit assembly as claimed in claim 18,
wherein
the regulating device of the charge pump is designed to regulate the voltage at the fifth node to a specifiable value.

20. The circuit assembly as claimed in claim 18,
wherein
the regulating device of the charge pump has the form of an inverting voltage regulator.

21.-24. (canceled)
